(19) United States
(12) Patent Application Publication
(10) Pub. No.: US 2008/0112512 A1
(43) Pub. Date: May 15, 2008

(54) TRANSMITTED REFERENCE SIGNALING SCHEME

(75) Inventors: Amal Ekbal, San Diego, CA (US); Chong U. Lee, San Diego, CA (US); David Jonathan Julian, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 11/560,310

(22) Filed: Nov. 15, 2006

(51) Int. Cl. H04L 27/06

(52) U.S. Cl. 375/340

(57) ABSTRACT

A signaling scheme employs transmitted reference pulses having varying phase. The phase of the reference pulses may be varied in a random manner or in accordance with a data stream. In some aspects a transmitter modulates the phase of the reference pulses to encode an additional data stream in a transmitted reference signal. In some aspects these techniques are employed in a heterogeneous network including coherent and non-coherent receivers. In some aspects these techniques may be employed in an ultra-wide band system.

### BACKGROUND

1. Field

This application relates generally to communications, and to a transmitted reference signaling scheme.

2. Background

In a typical communication system a transmitter sends data to a receiver via a communication medium. For example, a wireless device may send data to another wireless device via radio frequency (“RF”) signals that travel through the air. In general, transmission of signals through a communication medium will result in the received signals being distorted in some manner. Accordingly, a transmitter and a receiver will typically invoke some form of encoding/decoding scheme that enables the receiver to accurately recover data from received signals that have been distorted.

In some applications data may be encoded as a stream of signals each of which has a given amplitude, phase and position in time. For example, a pulse position modulation scheme involves sending a series of pulses where the position of each pulse in time is modulated according to a particular data value that pulse represents. Conversely, a phase shift keying modulation scheme may involve sending a series of pulses where the phase of each pulse is modulated according to a particular data value that pulse represents.

Various receiver architectures have been developed to recover data represented by such pulses. For example, a non-coherent receiver may simply detect the energy associated with each pulse in order to determine a value or position associated with the pulse. In general, non-coherent receivers are relatively simple and do not consume a significant amount of power. However, the performance of a non-coherent receiver may be unacceptable for some applications.

In contrast, a coherent receiver may provide relatively high performance by sampling received pulses at appropriate times such that the sampling will accurately derive magnitude and phase information conveyed by the pulses. This type of receiver architecture may, however, be relatively complicated and may consume a relatively significant amount of power.

A transmitted reference signaling scheme enables the use of a receiver structure with performance and complexity between the extremes of fully coherent and fully non-coherent receivers. In a transmitted reference scheme, a reference pulse is transmitted with every data pulse. That is, the data pulse closely follows the reference pulse in time. As a result, the reference and data pulses are distorted in a substantially similar manner by the communication channel. A transmitted reference receiver may thus employ a delayed correlator to demodulate the data, effectively using the reference pulse as a “noisy” matched filter.

It should be appreciated that different transceiver architectures such as those described above may provide different degrees of performance and may consume different amount of power. Consequently, for some applications undesirable tradeoffs may need to be made with regard to the selected transceiver architecture.

### SUMMARY

A summary of selected aspects of the disclosure follows. For convenience, one or more aspects may be referred to herein simply as “an aspect” or “aspects.”

In some aspects a signaling scheme employs transmitted reference pulses having varying phase. For example, in a transmitted reference system a modulation scheme is employed to transmit a data stream via reference pulses and associated data pulses. In addition, the phase of the reference pulses may be varied in a random manner, in accordance with the data stream or in accordance with another data stream.

In some aspects variation of the phase of the reference pulses improves the spectral characteristics of a transmitted reference signal. For example, random or pseudo-random variation of the phase of the reference pulses may reduce the magnitude and/or number of certain frequency components (e.g., spectral lines) of a frequency spectrum resulting from transmission of the transmitted reference signal.

In some aspects a transmitter modulates the phase of reference pulses to encode an additional data stream in a transmitted reference signal. For example, a receiver such as a coherent receiver that is capable of detecting each pulse in the transmitted reference signal may detect the phase of the reference pulses and the data pulses. Consequently, the receiver may decode data streams associated with modulation of both the reference pulses and the data pulses. Advantageously, this may be accomplished without substantially affecting the power consumption of the transmitter.

In some aspects the transmitter encodes the additional data stream by encoding a redundant data stream into a transmitted reference signal. Here, the redundant data stream may be identical to a main data stream that modulates the data pulse of the transmitted reference signal. A receiver may thus use the redundant data stream to improve decoding of the main data stream. In this way, the performance of the receiver and/or the coverage area of the transmitter may be improved.

In some aspects the transmitter encodes the additional data stream by encoding a second data stream into a transmitted reference signal. In this case, the second data stream is different than the main data stream that modulates the data pulse. A transmitter may use the second data stream to provide additional data services to a receiver.

In some aspects these techniques may be advantageously employed in a heterogeneous network. For example, a transmitter may use a single form of a transmitted reference signal to send a data stream to a conventional transmitted reference receiver and to a coherent receiver. Here, the transmitter may encode an additional data stream (e.g., redundant data stream or second data stream) in the transmitted reference signal for transmission to the coherent receiver. Advantageously, the transmitter may send this additional information to the coherent receiver without affecting the operation of the conventional transmitted reference receiver. In other words, the transmitter need not modify its signaling scheme to communicate with the different types of receivers.

In some aspects these techniques may be employed in a relatively wideband communication system. For example, the reference and data pulses may comprise ultra-wide band pulse signals.

### BRIEF DESCRIPTION OF THE DRAWINGS

These and other features, aspects and advantages of the disclosure will be more fully understood when considered with respect to the following detailed description, appended claims and accompanying drawings, wherein:

FIG. 1 is a simplified block diagram of several exemplary aspects of an apparatus that provides a reference signal with varying phase;

FIG. 2 is a flowchart of several exemplary aspects of operations that may be performed to provide a reference signal with varying phase;

FIG. 3, including FIGS. 3A-3D, illustrates several simplified examples of transmitted reference signals;

FIG. 4 is a simplified block diagram of several exemplary aspects of an apparatus that generates transmitted reference signals;

FIG. 5 is a flowchart of several exemplary aspects of operations that may be performed to generate transmitted reference signals;

FIG. 6 is a simplified diagram of several exemplary aspects of a heterogeneous communication system;

FIG. 7 is a simplified block diagram of several exemplary aspects of an apparatus that demodulates a transmitted signal;

FIG. 8 is a flowchart of several exemplary aspects of operations that may be performed to demodulate a transmitted signal;

FIG. 9 is a simplified block diagram of several exemplary aspects of an apparatus that demodulates a transmitted reference signal;

FIG. 10 is a flowchart of several exemplary aspects of operations that may be performed to demodulate a transmitted reference signal;

FIG. 11 is a simplified block diagram of several exemplary aspects of an apparatus that demodulates one or more data streams of a transmitted reference signal;

FIG. 12 is a flowchart of several exemplary aspects of operations that may be performed to demodulate one or more data streams of a transmitted reference signal;

FIG. 13 is a simplified block diagram of several exemplary aspects of a transmitter apparatus; and

FIG. 14 is a simplified block diagram of several exemplary aspects of a receiver apparatus.

In accordance with common practice the various features illustrated in the drawings may not be drawn to scale. Accordingly, the dimensions of the various features may be arbitrarily expanded or reduced for clarity. In addition, some of the drawings may be simplified for clarity. Thus, the drawings may not depict all of the components of a given apparatus or method. Finally, like reference numerals may be used to denote like features throughout the specification and figures.

### DETAILED DESCRIPTION

Various aspects of the disclosure are described below. It should be apparent that the teachings herein may be embodied in a wide variety of forms and that any specific structure and/or function disclosed herein is merely representative. Based on the teachings herein one skilled in the art should appreciate that an aspect disclosed herein may be implemented independently of any other aspects and that two or more of these aspects may be combined in various ways. For example, an apparatus may be implemented and/or a method practiced using any number of the aspects set forth herein. In addition, an apparatus may be implemented and/or a method practiced using other structure and/or functionality in addition to or other than one or more of the aspects set forth herein.

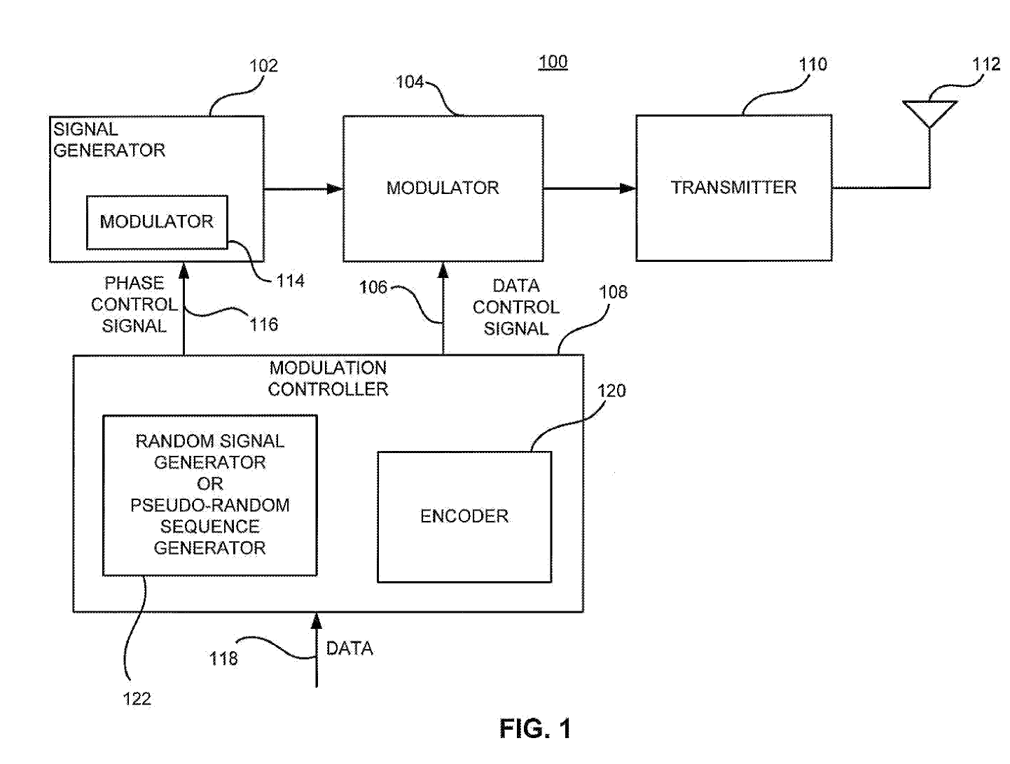

FIG. 1 illustrates several aspects of an apparatus 100 that comprises a portion of a transmit section of a wireless communication device. In this simplified example a signal generator 102 generates a signal that is modulated by a modulator 104. The modulator 104 is adapted to modulate the signal in accordance with a data control signal 106 from a modulation controller 108. Here, the control signal 106 may comprise data or some other information representative of a data stream to be transmitted to a receiver (not shown). The modulated signal is then provided to a transmitter 110 for transmission via an antenna 112 over a wireless communication medium.

In some aspects the signal generator 102 incorporates modulator functionality 114 that modulates the phase of the generated signal in accordance with a phase control signal 116 from the controller 108. For example, the signal generator 102 may generate reference pulses for a transmitted reference signal wherein the phase control signal 114 controls the phase of each generated reference pulse. The discussion that follows describes several exemplary components and operations in relation to such a transmitted reference system. It should be appreciated, however, that the teachings herein may be applicable to other types of data transmission schemes.

In some aspects the generated signals comprise ultra-wide band (“UWB”) signals. An ultra-wide band signal may be defined, for example, as a signal having a fractional bandwidth on the order of 20% or more and/or having a bandwidth on the order of 500 MHz or more. It should be appreciated that the teachings herein may be applicable to other types of signals having various frequency ranges and bandwidths. Moreover, such signals may be transmitted via a wired or wireless medium.

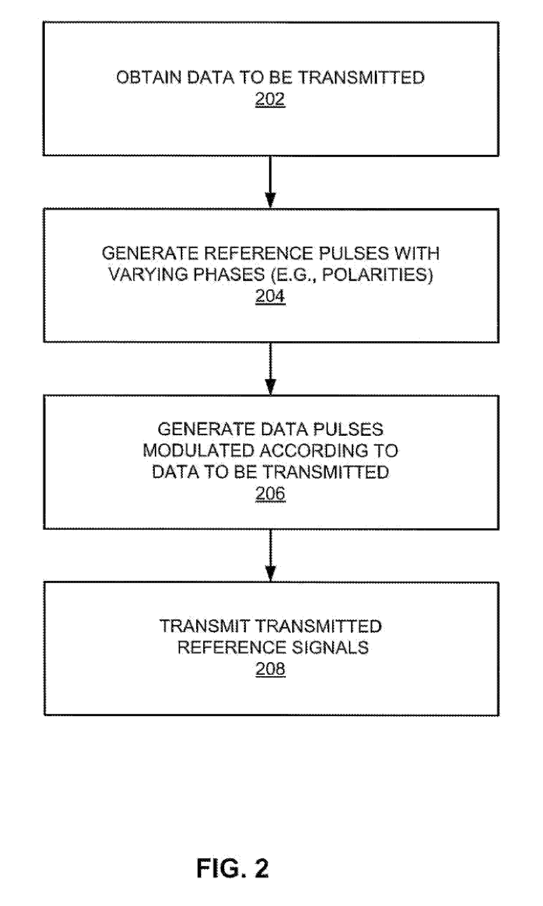

Several exemplary operations that may be used to provide a modulated reference pulse will now be discussed in conjunction with the flowchart of FIG. 2. For convenience, the operations of FIG. 2 (and any other flowchart herein) may be described as being performed by specific components. It should be appreciated, however, that these operations may be performed in conjunction with and/or by other components.

As represented by block 202, initially the wireless device generates or otherwise obtains data that is to be transmitted over the wireless communication medium to the receiver. In FIG. 1, data is shown as being provided to the modulation controller 108 as represented by a line 118. As will be discussed in more detail below, the data 118 may comprise one or more data streams.

As represented by block 204, the signal generator 102 generates reference pulses with varying phases. The signal generator 102 may employ various techniques to generate modulated pulses in this manner. For example, the signal generator 102 may generate a pulse then process the pulse to change the phase of the pulse. Alternatively, the signal generator 102 may generate each pulse with the appropriate phase. Furthermore, the signal generator 102 may implement different types of phase variation schemes. For example, the signal generator 102 may employ an n-ary phase modulation scheme where a pulse is generated with one of two, three, four or more different phases. For convenience, the discussion that follows describes a pulse modulation scheme that employs two phases that are 180° apart. It should be appreciated, however, that the teachings herein are not limited to signals having only two phases.

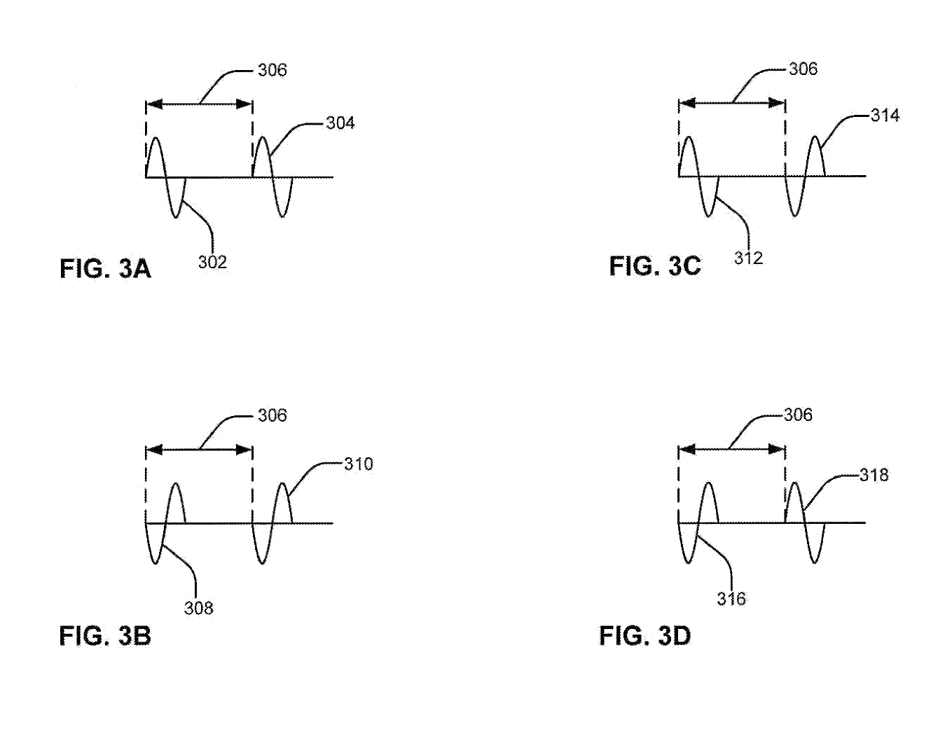

Referring to FIG. 3, four different transmitted reference signals are shown in FIGS. 3A, 3B, 3C and 3D. In each case, a reference pulse 302, 308, 312 or 316 is followed after a delay period 306 by a data pulse 304, 310, 314 or 318, respectively. As depicted in FIGS. 3A and 3B, a reference pulse 302 or 308 may be generated with one of two different phases (e.g., polarities).

Referring again to FIG. 1, the apparatus 100 may modulate the reference pulses in various ways for various purposes. For example, as will be discussed in more detail below in some aspects the reference pulses may be modulated in accordance with a data stream. Here, an encoder 120 or some other suitable component may generate the phase control signal 116 based on the data stream (e.g., a main data stream or an additional data stream of data 118). In this way, modulation of the reference pulses may be used to convey the data stream to the receiver.

In other aspects, the apparatus 100 may modulate the reference pulses to improve spectral characteristics of the transmitted reference signal. For example, the phase of the reference pulse may be varied in a random or pseudo-random manner. In this case, the frequency spectrum resulting from the transmitted reference signal may not have as many peaks and valleys associated with certain frequency components as would a signal without such modulation of the reference pulse. That is, modulation of the reference pulses may reduce the magnitudes of these frequency components of the frequency spectrum.

The signal generator 102 may randomly or pseudo-randomly modulate a reference pulse in various ways. For example, modulation of the reference pulse in accordance with data to be transmitted may provide relatively random variations in the phase of the reference pulse. Alternatively, a random signal generator or pseudo-random sequence generator 122 may generate a signal that controls the modulation of the reference pulse. This latter approach may be used, for example, when the reference pulse is not used to send data to the receiver.

Referring again to FIG. 2, as represented by block 206, the modulator 104 generates data pulses that are modulated in accordance with data to be transmitted to the receiver. Here, the encoder 120 or some other suitable component may encode data and/or generate signals based on the data (e.g., the main data stream from data 118) to facilitate modulation of the data pulses. Various modulation schemes may be employed in conjunction with the teachings herein. For example, FIG. 3 illustrates a binary phase shift keying (“BPSK”) modulation scheme. Referring to FIG. 3A, a binary zero may be designated when the data pulse 304 is the same phase (polarity) as the reference pulse 302. Conversely, as depicted in FIG. 3C, a binary one may be designated when the data pulse 314 has a different phase (polarity) than the reference pulse 312. FIGS. 3B and 3D illustrate a similar relationship when the phase (polarity) of the reference pulse 308 or 316 is reversed.

Alternatively, the apparatus 100 may employ a pulse position modulation scheme. Here, the delay 306 may be varied to represent a binary zero or a binary one. That is, a binary zero may be designated when a data pulse follows and associated reference pulse by a first time period. A binary one may then be designated when the data pulse follows the reference pulse by a second time period that is different than the first time period. In such a modulation scheme, the relative phases (polarities) of the reference and data pulses may not effect the modulation of the data pulses. Consequently, modulation of the phase (polarity) of the reference pulse as discussed above may be employed to provide an additional data stream to a coherent receiver.

FIG. 3 also illustrates that modulation of the phase of the reference pulse may be used in conjunction with modulation of the phase of the data pulse. For example, as discussed above FIG. 3A may represent a binary zero for a given phase (e.g., positive polarity) of the reference pulse. In addition, FIG. 3B may represent a binary zero for another phase (e.g., negative polarity) of the reference pulse. Conversely, FIG. 3C may represent a binary one for the positive phase while FIG. 3D represents a binary one for the negative phase. These relationships may be advantageously employed in a scheme that is used to send data to a traditional transmitted reference receiver and to a coherent receiver

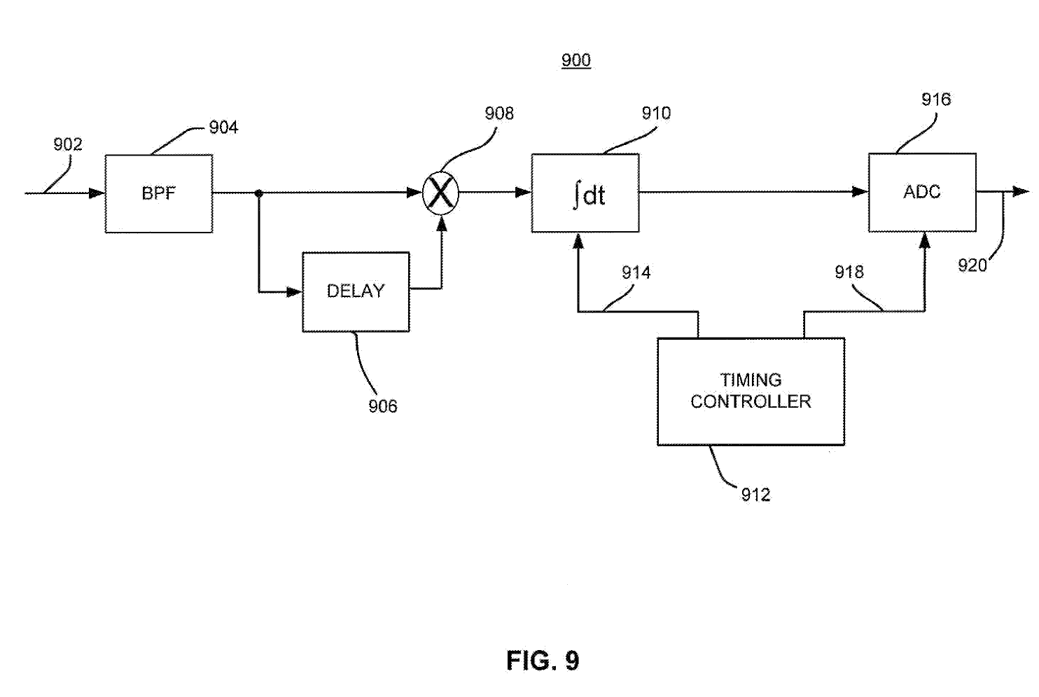

In a conventional transmitted reference receiver that employs a delayed correlator the waveforms of FIGS. 3A and 3B may be indistinguishable. That is, a conventional delayed correlator may only be capable of detecting the relative phases of the pulses. Thus, since the relative phases between the pulses of FIGS. 3A and 3B are the same and the relative phases between the pulses of FIGS. 3C and 3D are the same, the delayed correlator will properly decode the data pulse modulation in either one of the waveforms in a given pair. In other words, transmission of a binary zero via a waveform in the form of FIG. 3A or FIG. 3B will not affect the operation of the delayed correlator. Additional details relating to exemplary operations of a delayed correlator are discussed in more detail below in conjunction with FIG. 9.

In contrast, a coherent receiver may be capable of distinguishing between the waveforms of FIGS. 3A and 3B or between the waveforms of FIGS. 3C and 3D. For example, a coherent receiver may be adapted to detect the actual phase of each pulse in a transmitted reference signal. Consequently, a coherent receiver may decode a data stream that is encoded in a transmitted reference signal, at least in part, by phase modulation of the reference pulses (e.g., by sending the waveform of FIG. 3A or FIG. 3B).

Advantageously, such a modulation scheme may be employed whereby a change in phase of the reference pulse may be provided in conjunction with a corresponding change in the phase of the data pulse. In this way, the relative phase (polarity) between the reference and data pulses that conveys the data pulse modulation may be maintained. Consequently, the transmitted reference signal may include an additional data stream that may be detected by a coherent receiver without affecting the operation of any conventional transmitted reference receivers that receive this signal.

The additional data stream may be encoded in the transmitted reference signal in a variety of ways. For example, in some aspects the phase of the reference pulse or the phase of the data pulse may directly represent a data bit. An example using the reference pulse follows. It should be appreciated, however, that a similar scheme may be employed using the data pulse.

Referring again to FIG. 3, a binary zero for the additional data stream may be represented by a positive phase (polarity) of the reference pulse. In this case, the waveform of FIG. 3A is transmitted to send this binary zero in conjunction with a binary zero in the main data stream defined by the relative phase of the data pulse. Conversely, the waveform of FIG. 3C is transmitted to send this binary zero in conjunction with a binary one in the main data stream defined by the relative phase of data pulse.

Conversely, a binary one for the additional data stream may be represented by a negative phase (polarity) of the reference pulse. In this case, the waveforms of FIGS. 3B and 3D are transmitted to send this binary one in conjunction with a binary zero or a binary one, respectively, in the main data stream defined by the relative phase of the data pulse.

An example of these relationships is depicted in Table 1. Here, for the coherent receiver the bit associated with the additional data stream is listed in the right-hand column. Conversely, the bit associated with a relative phase of the data pulse is listed in the left column. Table 1 also illustrates that a conventional transmitted reference (“TR”) receiver only decodes the data stream associated with the relative phase of the data pulse.

TABLE 1

Signal

| | Coherent Receiver | TR Receiver |
|---|---|---|
| FIG. 3A | 00 | 0 |
| FIG. 3B | 01 | 0 |
| FIG. 3C | 10 | 1 |
| FIG. 3D | 11 | 1 |

In some aspects the relative phases (polarities) of subsequent reference pulses or subsequent data pulses are used to define the additional data stream. For example, no change in phase (polarity) from one reference pulse to the next reference pulse may represent a binary zero. Conversely, a change in phase (polarity) from one reference pulse to the next reference pulse may represent a binary one. In the latter case, the phase (polarity) of the data pulse may be reversed in response to the change in the phase (polarity) of the reference pulse to maintain the relative reference to data pulse phase relationship for the data pulse modulation.

A specific example of this type of modulation will be treated with reference to the reference pulses depicted in FIG. 3. A transition from the waveform of FIG. 3A (prior state) to the waveform of FIG. 3C (current state) may represent a binary zero for the additional data stream. In addition, the current state of the data bit associated with modulation of the data pulse may indicate a binary one due to the out-of-phase relationship between pulses 312 and 314 in FIG. 3C.

Conversely, a transition from the waveform of FIG. 3A (prior state) to the waveform of FIG. 3B (current state) may represent a binary one for the additional data stream. In addition, the current state of the data bit associated with modulation of the data pulse may indicate a binary zero due to the in-phase relationship between pulses 308 and 310 in FIG. 3B.

It should be appreciated that other techniques may be employed to modulate the pulses in accordance with data. For example, a convolutional encoding scheme or some other type of encoding scheme may be employed. In addition, any of the above schemes may employ an n-ary modulation scheme wherein 2, 3 or more values may be represented by a signal. Moreover, more than one modulation scheme may be used to modulate a signal.

Referring again to FIG. 2, as represented by block 208, the transmitter 110 (FIG. 1) transmits the modulated reference and data pulses as a transmitted reference signal to the receiver. Thus, the signal generator 102 continuously generates reference pulses that may be modulated by the phase control signal 116, and the modulator 104 continually modulates data pulses modulated by the data control signal 106.

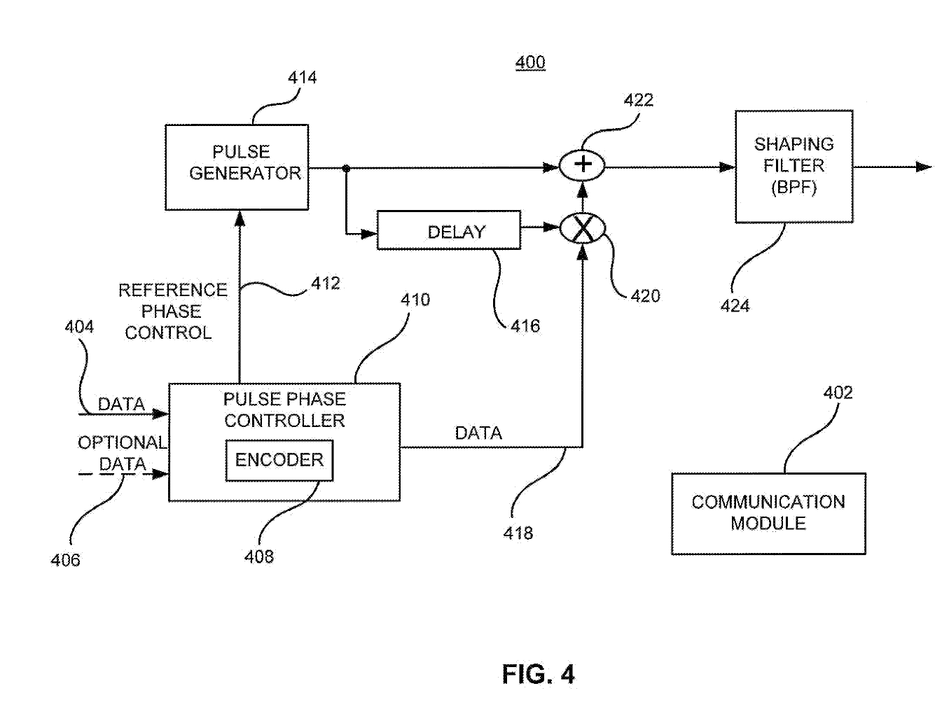

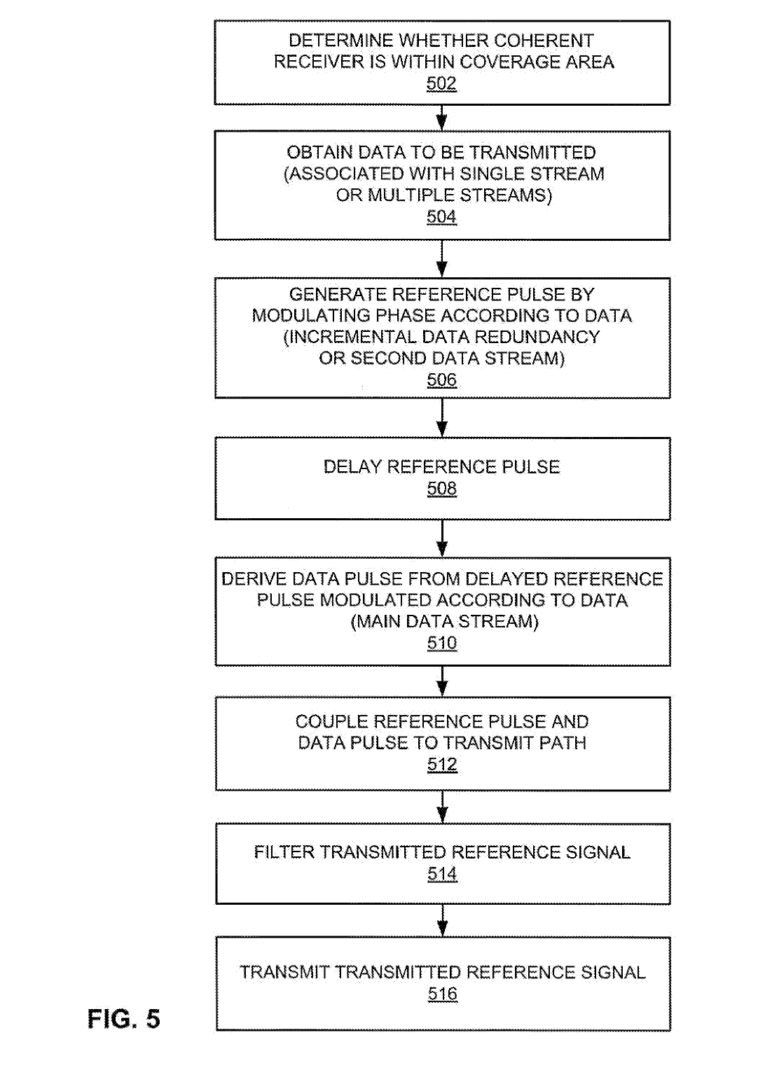

Additional details of several examples of the transmission and reception of modulated signals will be treated in conjunction with FIGS. 4-12. FIG. 4 illustrates several aspects of an apparatus 400 adapted to generate transmitted reference signals in accordance with the teachings herein. FIG. 5 illustrates several operations that may be performed to generate and transmit transmitted reference signals.

As represented by block 502 in FIG. 5, initially a wireless device may be configured to provide an additional data stream or the wireless device may determine whether to provide an additional data stream. As an example of the former, in some cases (e.g., where it is not possible to determine corresponding capabilities of a nearby wireless device) a first wireless device may be configured to always provide the additional data stream. In this way, in the event a second wireless device with appropriate capabilities enters the coverage area of the first wireless device, the additional data stream is readily available to the second wireless device. As discussed above, the second wireless device may comprise a coherent receiver or some other apparatus capable of determining the actual phases of the reference and data pulses in a transmitted reference signal. Alternatively, in some cases a communication module 402 of a first wireless device may determine whether a second wireless device capable of receiving an additional data stream is within the coverage area of the first wireless device. In this case, the first wireless device may only provide the additional stream when such a second wireless device is in position to receive the data stream. Thus, in the two examples described above, the first wireless device may provide capabilities such an extended service area (e.g., via incremental data redundancy) or additional services (e.g., via a second data stream) on a continual or selective basis.

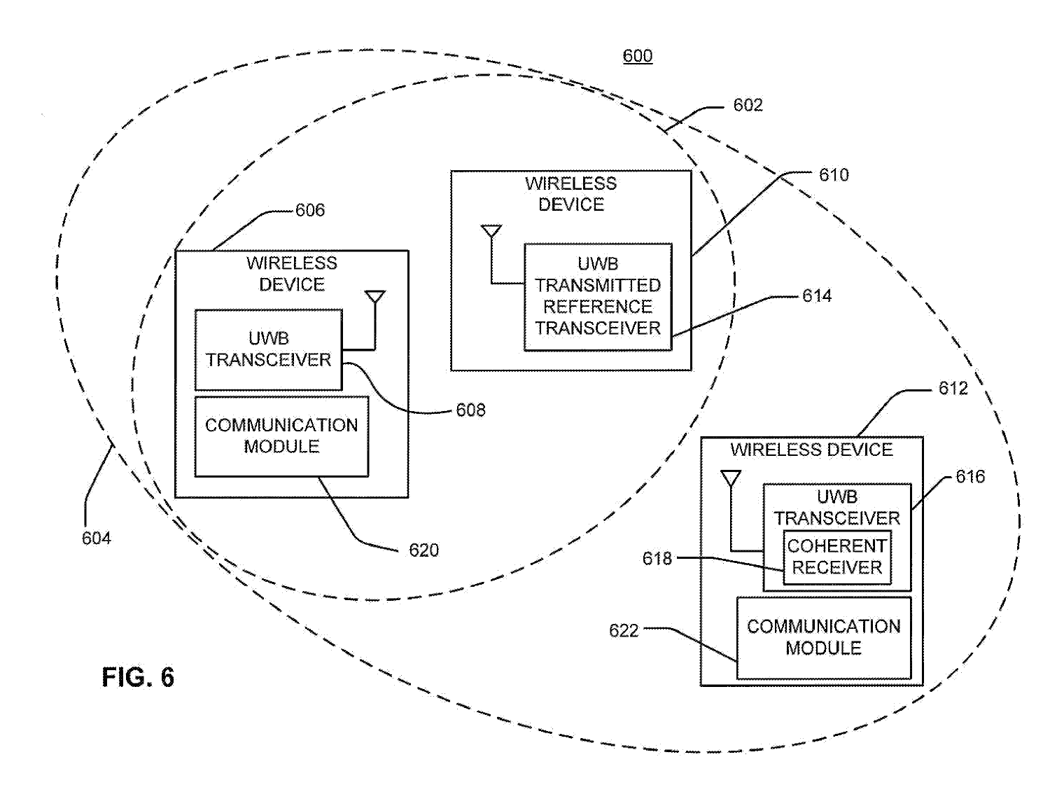

FIG. 6 depicts two simplified examples of wireless coverage areas 602 and 604 (represented by the dashed ovals) associated with a wireless device 606. In one example to be discussed below the coverage area of an ultra-wide band transceiver 608 of the wireless device 606 is limited to the range represented by coverage area 602. In another example to be discussed below the coverage area of the transceiver 608 encompasses the range represented by coverage area 604. Accordingly, in the first example only a wireless device 610 is in the coverage area 602. Conversely, in the second example the wireless device 610 and a wireless device 612 are in the coverage area 604.

The wireless device 610 includes an ultra-wide band transmitted reference transceiver 614. In this example, the transceiver 614 implements a delayed correlator or some other type of receiver that is not fully-coherent. Hence, the wireless device 610 does not include a suitable component for receiving from the wireless device 606 an additional data stream encoded in a transmitted reference signal.

In contrast, an ultra-wide band transceiver 616 of the wireless device 612 includes a coherent receiver 618. Thus, the wireless device 612 may be capable of receiving an additional data stream encoded in a transmitted reference signal from the wireless device 606.

In the first example, a communication module 620 (e.g., module 424 of FIG. 4) of the wireless device 606 attempts to communicate with any wireless devices in the coverage area 602. In this case, a determination is made that the wireless device 610 is not capable of receiving the additional data stream. Accordingly, the wireless device 606 may elect to not provide the additional data stream in its transmitted reference signal. That is, the transceiver 608 may transmit a conventional transmitted reference signal that only includes modulation of the data pulse.

Conversely, in the second example the communication module 620 attempts to communicate with any wireless devices in the coverage area 604. In this case, a communication module 622 in the wireless device 612 may confirm that the wireless device 612 is capable of receiving the additional data stream. Accordingly, the wireless device 606 may provide the additional data stream in its transmitted reference signal. Advantageously, as discussed above the additional data stream may be encoded in the transmitted reference signal in a manner that does not affect the reception of the transmitted reference signal by the wireless device 610.

Referring again to FIG. 5, as represented by block 504 the apparatus 400 generates or otherwise obtains one or more data streams to be transmitted to a receiver (e.g., receiver 618). As discussed above, a transmitted reference signaling scheme may transmit a data stream (e.g., a main data stream) by modulating the data pulses of the transmitted reference signal. Accordingly, FIG. 4 illustrates incoming data 404 representative of the main data stream.

In addition, a transmitted reference signaling scheme as taught herein may transmit an additional data stream by modulating the reference pulses and/or the data pulses. In some cases this additional data stream may comprise a data stream that is different than the main data stream. Accordingly, FIG. 4 illustrates optional incoming data 406 represented of a second data stream. As discussed above, the apparatus 400 may utilize an additional data stream such as the one provided by the data 406 if a suitable receiver is within the coverage area of the apparatus 400.

For convenience, the discussion that follows will simply describe the use of one additional data stream. However, it should be appreciated that some implementations may employ two or more data streams depending upon the particular scheme used for modulating the transmitted reference signal.

As represented by block 506, in the event the apparatus 400 provides an additional data stream, an encoder 408 may perform an encoding operation in accordance with the data to be used to modulate the reference pulse and, optionally, the data pulse. Based on this encoding operation, a pulse phase controller 410 generates a reference phase control signal 412 that controls the phase of the reference pulses generated by a pulse generator 414.

As discussed above, the additional data stream may provide redundancy for the main data stream or may comprise a second data stream. Thus, in the former case the encoder 408 may use the data 404 to modulate the reference pulse. In some aspects a receiver may use a redundant data stream to improve decoding of the main data stream. In this case, the performance of the receiver and/or the coverage area of the transmitter may be improved. For example, through the use of incremental data redundancy a larger coverage area may be established between a transmitter and a coherent receiver since the receiver may be able to accurately extract data from received pulses even if those pulses include more distortion due to the longer distance between the transmitter and the receiver. Referring to the simplified example of FIG. 6, the wireless device 612 may thus be capable of reliably receiving signals from the wireless device 606 over the larger coverage area 604. In contrast, the wireless device 602 may only be capable of reliably receiving signals from the wireless device 606 over the smaller coverage area 602.

When the additional data stream comprises a second data stream, the encoder 408 may use the data 406 to modulate the reference pulse. In this case, a transmitter may employ the second stream to provide additional data services to a coherent receiver. For example, the transmitter may send a basic audio broadcast via the main data stream while providing enhancements to the audio broadcast via the second data stream. Thus, a conventional transmitted reference receiver may receive the basic audio broadcast while a coherent receiver may receive an enhanced audio broadcast.

As represented by block 508, a reference pulse generated by the pulse generator 414 is fed to a delay circuit 416. In applications that support pulse position modulation of the data pulse (not depicted in FIG. 4) the delay provided by the delay circuit 416 may be modulated in accordance with data to be transmitted.

As represented by block 510, the apparatus 400 derives a data pulse from the delayed reference pulse. For example, the delayed reference pulse may be modulated by data to be transmitted in accordance with a given modulation scheme as discussed above. In the example of FIG. 4 the encoder 408 may generate a data signal 418 based on the data 404. In addition, as discussed above, the phase (polarity) of the data pulse may be affected by modulation of the reference pulse. Hence, the encoder 408 may modify the data signal 418 based on the additional data stream. Furthermore, in some applications data bits to be transmitted are provided to a spreading code generator to provide the data signal 418. In the binary phase shift keying example shown in FIG. 4, a multiplier 420 multiplies the delayed reference pulse with the data signal 418 (e.g., +1 or −1) representative of the encoded data to be transmitted to provide a data pulse. Alternatively, a phase shifter may be used to modulate the delayed pulse with the data to be transmitted (e.g., output by a spreading code generator) for phase shift keying employing two or more phases (M-PSK with M=2, 3, 4, etc.).

As represented by block 512, an adder 422 couples the original reference pulse along with the data pulse to an output path of the apparatus 100. The pulses are thus provided to a shaping filter (e.g., a bandpass filter) 424 at block 514 and processed as necessary for transmission over the communication medium (block 516).

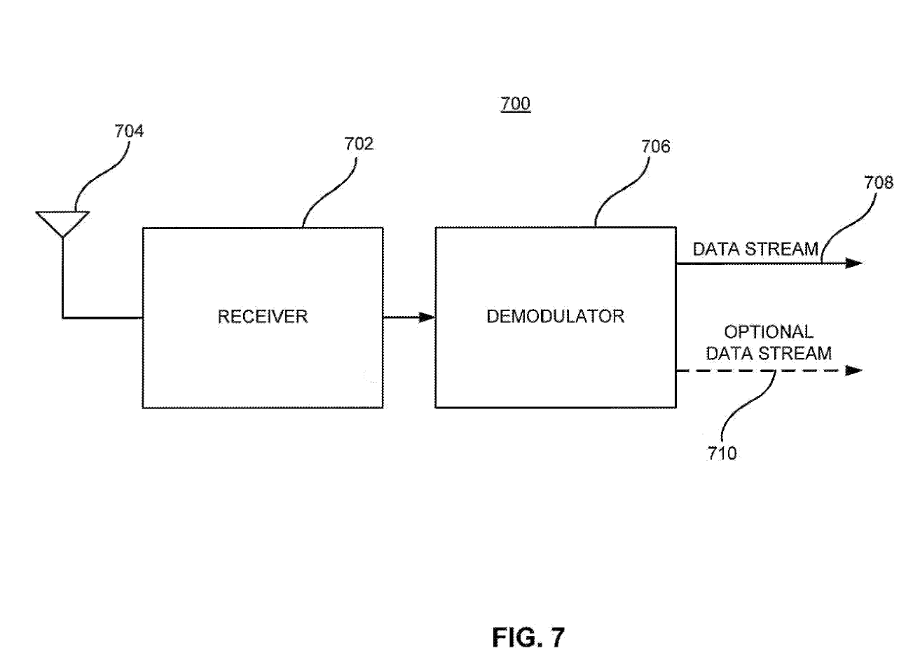

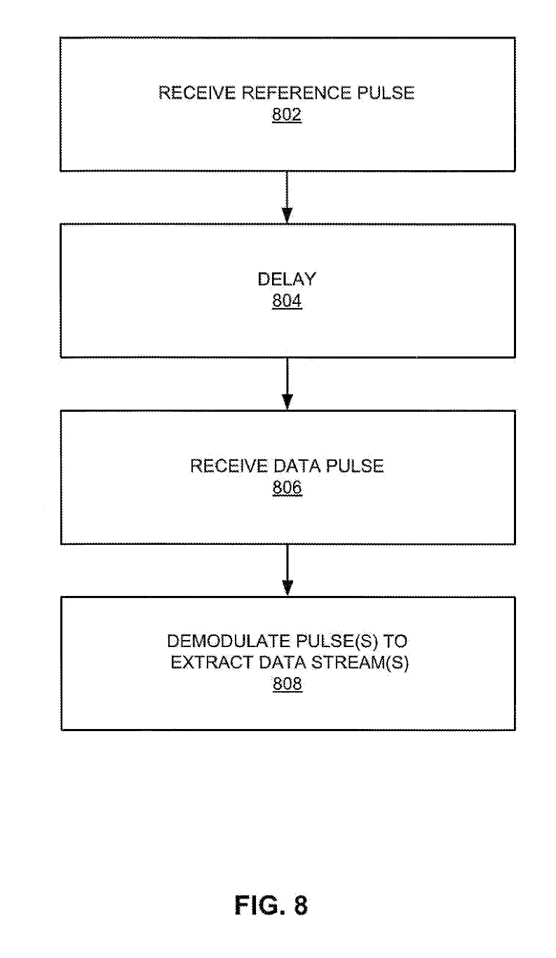

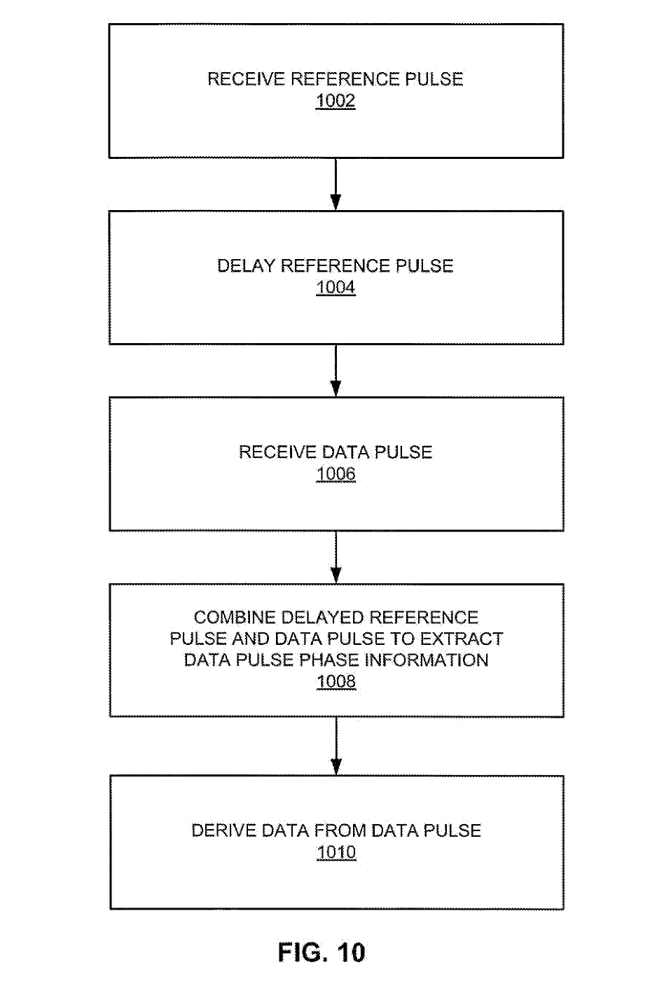

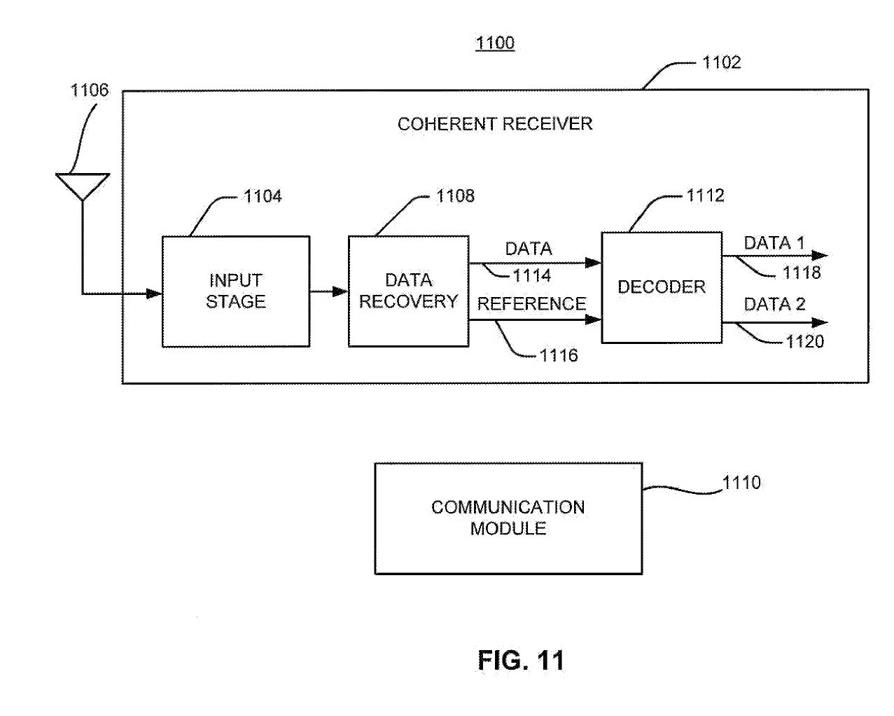

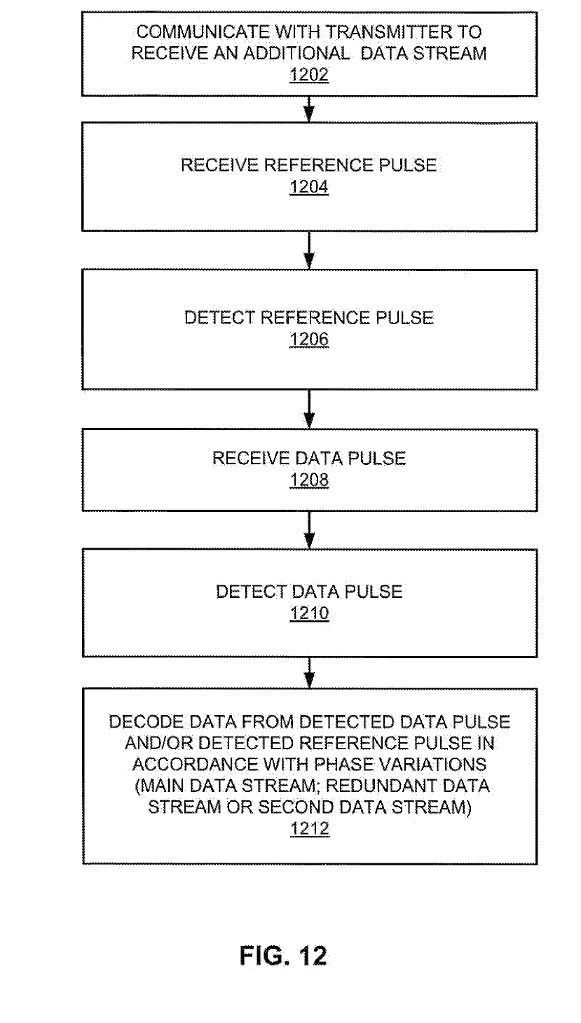

Referring now to FIGS. 7-12, various aspects relating to receiving transmitted reference signals as described above will be treated. FIGS. 7 and 8 relate to relatively high-level receiver components and operations. FIGS. 9 and 10 relate to a conventional transmitted reference receiver architecture. FIGS. 11 and 12 relate to a coherent receiver architecture.

In FIG. 7 an apparatus 700 processes a transmitted signal. The apparatus 700 includes a receiver 702 that receives an input signal from a communication medium via an antenna 704. The received signal is provided to a demodulator 706 that extracts a data stream 708 from the received signal. In addition, the demodulator 706 may extract an optional data stream 710 from the received signal.

FIG. 8 illustrates several operations that may be performed to demodulate a transmitted reference signal. Here, the receiver 702 receives a reference pulse (block 802) and, after a delay period (block 804), a data pulse (block 806).

As represented by block 808, the demodulator 706 demodulates the received pulses to provide the data stream 708 and, optionally, the data stream 710. The data stream 708 may comprise the main data stream discussed above that is derived from, for example, the data pulses of a transmitted reference signal. The optional data stream 710 may comprise the second data stream that is derived from, for example, the reference pulses and/or the data pulses of the transmitted reference signal.

FIG. 9 illustrates in more detail an apparatus 900 adapted to recover data from a phase modulated data pulse of a transmitted reference signal. Here, received signals 902 are filtered by a bandpass filter (“BPF”) 904 and then operated on by a delayed correlator including a delay circuit 906 and a multiplier 908 that, in effect, demodulates the data pulse.

Exemplary operations of the apparatus 900 will be discussed in conjunction with the flowchart of FIG. 10. As represented by block 1002, a received reference pulse is provided to an input of the delay circuit 906. As represented by block 1004, the delay circuit 906 delays the reference pulse in accordance with the proper reference pulse to data pulse delay. Consequently, when the corresponding data pulse is received (block 1006), the data pulse will be provided to an input of the multiplier 908 at substantially the same time as the delayed reference pulse is provided to another input of the multiplier 908 (block 1008).

Here, the delayed reference pulse effectively provides a matched filter for recovering the data from the data pulse. In some applications multiple pulses may have been transmitted for each pulse (e.g., using a spreading code) to improve the accuracy of the data recovery. Accordingly, provisions may be made in the receive process to accommodate the transmission of multiple pulses. In addition, in some applications several received reference pulses may be averaged to reduce the effects of the channel on these pulses. In this way, the characteristics of the effective matched filter may be improved.

An integrator 910 integrates the multiplied signal to provide a detected data pulse. Here, the operation of the integrator 910 may be controlled in accordance with a timing signal. For example, a timing controller 912 may generate a control signal 914 that is used to turn the integrator 910 on and off at the appropriate times to detect only each data pulse.

In some aspects the detected pulse is fed directly to an analog-to-digital converter (“ADC”) 916 that converts the detected pulse to a digital data signal 920 (block 1010). Here, the timing controller 912 may generate a control signal 918 that is used to turn the analog-to-digital converter 916 on and off at appropriate times to capture a signal output by the integrator 910 at an appropriate time. By turning off the converter 916 when it is not needed, the power consumed by the apparatus 900 may be reduced.

Various mechanisms may be employed to maintain synchronization between a transmitter and a receiver to generate the control signals 914 and 918 at the appropriate times. For example, the transmitter may occasionally send timing signals to the receiver.

In some aspects a peak detector (not shown) may be employed between the integrator 910 and the converter 916. In this case, the converter 916 may simply convert the detected peaks (e.g., positive and negative peaks) to provide the digital data signal 920. Such a configuration may be used, for example, when precise timing information is not used to control the integrator 910 and/or the converter 916. This may be the case when the timing of the peaks is not known or is not known with a high degree of certainty. In such a case, the timing controller 912 may be much less precise or, in some cases, may not be employed.

FIG. 11 illustrates several aspects of an apparatus 1100 incorporating a coherent receiver 1102. The receiver 1102 includes an input stage 1104 that is adapted to receive transmitted reference signals from a communication medium via an antenna 1106. The receiver 1102 also includes a data recovery module 1108 that is adapted to extract phase and other information from each received pulse. The data recovery module 1108 operates in conjunction with a decoder 1112 to, in effect, demodulate the data stream(s) from the received transmitted reference signal. Consequently, in contrast with the apparatus 900 discussed above, the apparatus 1100 may be adapted to recover an additional data stream that is encoded in the transmitted reference signal. Exemplary operations of the apparatus 1100 will be treated in conjunction with the flowchart of FIG. 12.

As represented by block 1202, the apparatus 1100 includes a communication module 1110 that may communicate with a transmitter to receive the additional data stream. For example, upon entering a coverage area of the transmitter, the communication module 1110 may send a message to the transmitter indicating that the apparatus 1100 is capable of receiving and wishes to receive an additional data stream. Conversely, the communication module may respond to an inquiry from a transmitter in a similar manner. This operation may be, for example, complementary to the operations discussed above in conjunction with block 502 and FIG. 6. That is, the communication module 1110 may incorporate the functionality of the communication module 622.

As represented by blocks 1204 and 1206, the data recovery module 1108 processes a received reference pulse to detect phase information and other relevant information (e.g., amplitude). For example, the data recovery module 1108 may sample the pulse at a relatively high rate and process the resultant data using a matched filter to determine, for example, the phase of the pulse. To this end, the receiver 1102 may include a mechanism for learning information regarding the communication medium (e.g., channel). The receiver 1102 may then use this information to generate the matched filter.

As represented by blocks 1208 and 1210, the data recovery module 1108 processes a receive data pulse to detect phase information and other relevant information (e.g., amplitude). This detection operation may be performed in a similar manner as the operation of block 1206

As represented by block 1212, the decoder 1112 decodes information 1114 relating to the data pulse to derive a main data stream 1118 and, if applicable, decodes information 1116 relating to the reference pulse to derive an additional data stream 1120. As discussed above, the additional data stream may comprise a redundant data stream or a second data stream. The decoder 1112 may then provide the signals 1118 and 1120 to other components that may further verify the data of the data stream(s). For example, in the case of incremental data redundancy, the data 1118 may be compared to the data 1120 to provide a final decision as to the value of the received data.

It should be appreciated that the teachings herein may be applicable to a wide variety of applications other than those specifically mentioned above. For example, the teachings herein may be applicable to systems utilizing different bandwidths, signal types (e.g., shapes), or modulation schemes. Also, an apparatus constructed in accordance with these teachings may take be implemented using various circuits including circuits other than those specifically described herein.

The teachings herein may be incorporated into a variety of devices. For example, one or more aspects taught herein may be incorporated into a phone (e.g., a cellular phone), a personal data assistant (“PDA”), an entertainment device (e.g., a music or video device), a headset, a microphone, a biometric sensor (e.g., a heart rate monitor, a pedometer, an EKG device, etc.), a user I/O device (e.g., a watch, a remote control, etc.), a tire pressure monitor, or any other suitable communicating device. Moreover, these devices may have different power and data requirements. Advantageously, the teachings herein may be adapted for use in low power applications (e.g., through the use of low duty cycle pulses). In addition, these teaching may be incorporated into an apparatus supporting various data rates including relatively high data rates (e.g., through the use of a circuit adapted to process high-bandwidth pulses).

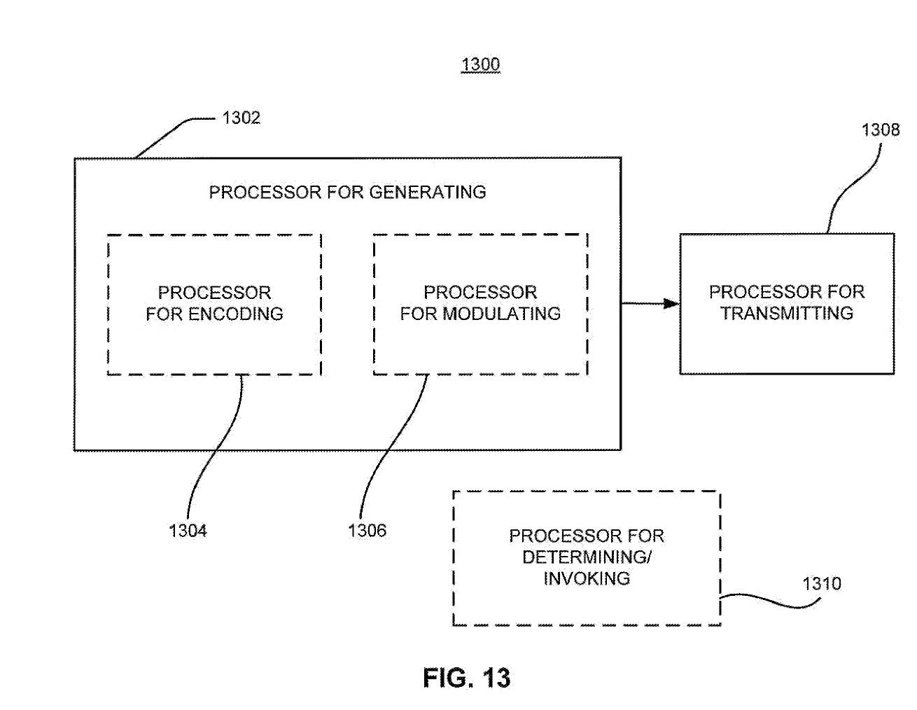

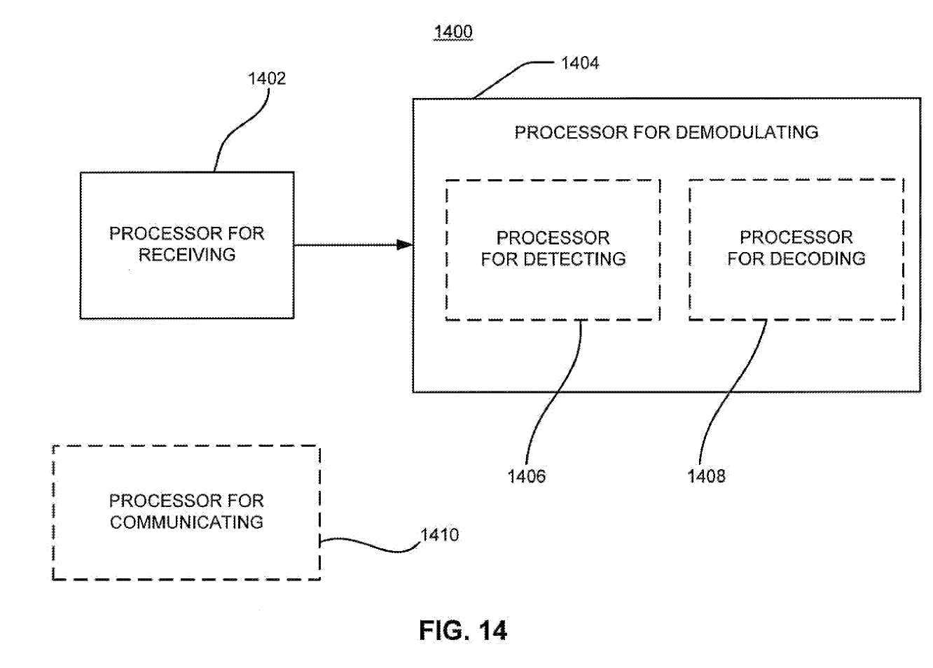

The components described herein may be implemented in a variety of ways. For example, referring to FIG. 13, an apparatus 1300 includes components 1302, 1304, 1306, 1308, and 1310 that may correspond to components 102, 120, 104 and 114, 110, and 402 discussed above. In addition, referring to FIG. 14, an apparatus 1400 includes components 1402, 1404, 1406, 1408, and 1410 that may correspond to components 702, 706, 1108, 1114, and 1110 discussed above. FIGS. 13 and 14 illustrate that in some aspects these components may be implemented via appropriate processor components. These processor components may in some aspects be implemented, at least in part, using structure as taught herein. In some aspects the components represented by dashed boxes are optional.

In addition, the components and functions represented by FIGS. 13 and 14, as well as other components and functions described herein, may be implemented using any suitable means. Such means also may be implemented, at least in part, using corresponding structure as taught herein. For example, in some aspects means for generating may comprise a generator, means for encoding may comprise an encoder, means for modulating may comprise a modulator, means for transmitting may comprise a transmitter, means for determining may comprise a communication module, means for invoking may comprise a communication module, means for receiving may comprise a receiver, means for demodulating may comprise a demodulator, means for detecting may comprise a detector, means for decoding may comprise a decoder, and means for communicating may comprise a communication module. In some aspects one or more of such means also may be implemented in accordance with one or more of the processor components of FIGS. 13 and 14.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware, various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. An exemplary storage medium may be coupled to a machine such as, for example, a computer/processor (which may be referred to herein, for convenience, as a “processor”) such the processor can read information (e.g., code) from and write information to the storage medium. An exemplary storage medium may be integral to the processor. The processor and the storage medium may reside in an ASIC. The ASIC may reside in user equipment. In the alternative, the processor and the storage medium may reside as discrete components in user equipment.

The previous description of the disclosed aspects is provided to enable any person skilled in the art to make or use the present disclosure. Various modifications to these aspects will be readily apparent to those skilled in the art, and the generic principles defined herein may be applied to other aspects without departing from the spirit or scope of the disclosure. Thus, the present disclosure is not intended to be limited to the aspects shown herein but is to be accorded the widest scope consistent with the principles and novel features disclosed herein.

What is claimed is:

1. A method of providing a transmitted reference signal having reference pulses and associated data pulses, comprising:
generating reference pulses with varying phases; and
transmitting the reference pulses and data pulses such that the reference pulses are adapted to be used to derive data from the data pulses.

2. The method of claim 1, wherein the varying phases further comprise varying polarities.

3. The method of claim 1, wherein transmitting the reference and data pulses further comprises transmitting a reference pulse and, after a delay period, transmitting an associated data pulse via a communication medium such that the reference and data pulses are distorted in a substantially similar manner by the communication channel.

4. The method of claim 1, wherein the phases of the reference pulses are varied randomly or in accordance with a pseudo-random sequence.

5. The method of claim 1, wherein the pulses further comprise ultra-wide band pulses having a fractional bandwidth on the order of 20% or more or having a bandwidth on the order of 500 MHz or more.

6. The method of claim 1, wherein the phases of the reference pulses are varied to improve spectral characteristics associated with the transmission of the reference and data pulses.

7. The method of claim 1, wherein generating the reference pulses further comprises modulating the phases of the reference pulses in accordance with data to be transmitted.

8. The method of claim 1, further comprising encoding incremental data redundancy, at least in part, in the reference pulses.

9. The method of claim 8, wherein the encoding further comprises convolutional encoding.

10. The method of claim 8, further comprising encoding the incremental data redundancy, at least in part, in the data pulses.

11. The method of claim 8, further comprising:
determining whether a coherent receiver is within a coverage area of a transmitter; and
invoking the encoding if the coherent receiver is within the coverage area.

12. The method of claim 8, wherein the encoding increases a coverage area of a transmitter.

13. The method of claim 1, further comprising encoding an additional data stream, at least in part, in the reference pulses.

14. The method of claim 13, wherein the encoding further comprises convolutional encoding.

15. The method of claim 13, further comprising encoding the additional data stream, at least in part, in the data pulses.

16. The method of claim 13, further comprising:
determining whether a coherent receiver is within a coverage area of a transmitter; and
invoking the encoding if the coherent receiver is within the coverage area.

17. The method of claim 13, wherein:
a transmitted reference receiver demodulates a main data stream from the transmitted reference and data pulses; and
a coherent receiver demodulates the additional data stream from at least the transmitted reference pulses.

18. The method of claim 1, wherein the method is performed in at least one of the group consisting of: a headset, a microphone, a biometric sensor, a heart rate monitor, a pedometer, an EKG device, a user I/O device, a watch, a remote control, and a tire pressure monitor.

19. An apparatus for providing a transmitted reference signal having reference pulses and associated data pulses, comprising:
a signal generator adapted to generate reference pulses with varying phases; and
a transmitter adapted to transmit the reference pulses and data pulses such that the reference pulses are adapted to be used to derive data from the data pulses.

20. The apparatus of claim 19, wherein the varying phases further comprise varying polarities.

21. The apparatus of claim 19, wherein the signal generator is further adapted to vary the phases of the reference pulses randomly or in accordance with a pseudo-random sequence.

22. The apparatus of claim 19, wherein the pulses further comprise ultra-wide band pulses having a fractional bandwidth on the order of 20% or more or having a bandwidth on the order of 500 MHz or more.

23. The apparatus of claim 19, further comprising a modulator adapted to modulate the phases of the reference pulses in accordance with data to be transmitted.

24. The apparatus of claim 19, further comprising an encoder adapted to encode incremental data redundancy, at least in part, in the reference pulses.

25. The apparatus of claim 24, wherein the encoder is further adapted to encode the incremental data redundancy, at least in part, in the data pulses.

26. The apparatus of claim 24, further comprising a communication module adapted to determine whether a coherent receiver is within a coverage area of the transmitter, wherein the encoder performs the encoding if the coherent receiver is within the coverage area.

27. The apparatus of claim 19, further comprising an encoder adapted to encode an additional data stream, at least in part, in the reference pulses.

28. The apparatus of claim 27, wherein the encoder is further adapted to encode the additional data stream, at least in part, in the data pulses.

29. The apparatus of claim 27, further comprising a communication module adapted to determine whether a coherent receiver is within a coverage area of the transmitter, wherein the encoder performs the encoding if the coherent receiver is within the coverage area.

30. The apparatus of claim 19, wherein the apparatus is implemented in at least one of the group consisting of: a headset, a microphone, a biometric sensor, a heart rate monitor, a pedometer, an EKG device, a user I/O device, a watch, a remote control, and a tire pressure monitor.

31. An apparatus for providing a transmitted reference signal having reference pulses and associated data pulses, comprising:
means for generating reference pulses with varying phases; and
means for transmitting the reference pulses and data pulses such that the reference pulses are adapted to be used to derive data from the data pulses.

32. The apparatus of claim 31, wherein the varying phases further comprise varying polarities.

33. The apparatus of claim 31, wherein the phases of the reference pulses are varied randomly or in accordance with a pseudo-random sequence.

34. The apparatus of claim 31, wherein the pulses further comprise ultra-wide band pulses having a fractional bandwidth on the order of 20% or more or having a bandwidth on the order of 500 MHz or more.

35. The apparatus of claim 31, wherein the means for generating the reference pulses further comprises means for modulating the phases of the reference pulses in accordance with data to be transmitted.

36. The apparatus of claim 31, further comprising means for encoding incremental data redundancy, at least in part, in the reference pulses.

37. The apparatus of claim 36, further comprising means for encoding the incremental data redundancy, at least in part, in the data pulses.

38. The apparatus of claim 36, further comprising:
means for determining whether a coherent receiver is within a coverage area of the means for transmitting; and
means for invoking the encoding if the coherent receiver is within the coverage area.

39. The apparatus of claim 31, further comprising means for encoding an additional data stream, at least in part, in the reference pulses.

40. The apparatus of claim 39, further comprising means for encoding the additional data stream, at least in part, in the data pulses.

41. The apparatus of claim 39, further comprising:
means for determining whether a coherent receiver is within a coverage area of the means for transmitting; and
means for invoking the encoding if the coherent receiver is within the coverage area.

42. The apparatus of claim 31, wherein the apparatus is implemented in at least one of the group consisting of: a headset, a microphone, a biometric sensor, a heart rate monitor, a pedometer, an EKG device, a user I/O device, a watch, a remote control, and a tire pressure monitor.

43. A computer-program product for providing a transmitted reference signal having reference pulses and associated data pulses comprising:
a computer-readable medium comprising codes for causing a computer to:
generate reference pulses with varying phases; and
transmit the reference pulses and data pulses such that the reference pulses are adapted to be used to derive data from the data pulses.

44. A processor for providing a transmitted reference signal having reference pulses and associated data pulses, the processor being adapted to:
generate reference pulses with varying phases; and
transmit the reference pulses and data pulses such that the reference pulses are adapted to be used to derive data from the data pulses.

45. A method of processing a transmitted reference signal including reference pulses and data pulses, comprising:
receiving reference pulses and data pulses of a transmitted reference signal; and
demodulating data transmitted in the transmitted reference signal, at least in part, in accordance with changes in phase of the reference pulses.

46. The method of claim 45, wherein the changes in phase further comprise changes in polarity.

47. The method of claim 45, wherein receiving the reference pulses and the data pulses further comprises receiving a reference pulse and, after a delay period, receiving an associated data pulse.

48. The method of claim 45, wherein demodulating the data further comprises detecting random or pseudo-random changes in the phase of the reference pulses.

49. The method of claim 45, wherein the transmitted reference signal further comprises an ultra-wide band signal having a fractional bandwidth on the order of 20% or more or having a bandwidth on the order of 500 MHz or more.

50. The method of claim 45, wherein demodulating the data further comprises decoding, at least in part, the reference pulses to extract incremental data redundancy from the transmitted reference signal.

51. The method of claim 50, further comprising decoding, at least in part, the data pulses to extract the incremental data redundancy from the transmitted reference signal.

52. The method of claim 50, wherein a coherent receiver performs the decoding.

53. The method of claim 50, further comprising communicating with a transmitter to invoke a capability of the transmitter to transmit the transmitted reference signal with the incremental data redundancy.

54. The method of claim 45, wherein demodulating the data further comprises decoding, at least in part, the reference pulses to extract an additional data stream from the transmitted reference signal.

55. The method of claim 54, further comprising decoding, at least in part, the data pulses to extract the additional data stream from the transmitted reference signal.

56. The method of claim 54, wherein a coherent receiver performs the decoding.

57. The method of claim 54, further comprising communicating with a transmitter to invoke a capability of the transmitter to transmit the transmitted reference signal with the additional data stream.

58. The method of claim 45, wherein the method is performed in at least one of the group consisting of: a headset, a microphone, a biometric sensor, a heart rate monitor, a pedometer, an EKG device, a user I/O device, a watch, a remote control, and a tire pressure monitor.

59. An apparatus for processing a transmitted reference signal including reference pulses and data pulses, comprising:
a receiver adapted to receive reference pulses and data pulses of a transmitted reference signal; and
a demodulator adapted to demodulate data transmitted in the transmitted reference signal, at least in part, in accordance with changes in phase of the reference pulses.

60. The apparatus of claim 59, wherein the changes in phase further comprise changes in polarity.

61. The apparatus of claim 59, wherein the demodulator is further adapted to detecting random or pseudo-random changes in the phase of the reference pulses.

62. The apparatus of claim 59, wherein the transmitted reference signal further comprises an ultra-wide band signal having a fractional bandwidth on the order of 20% or more or having a bandwidth on the order of 500 MHz or more.

63. The apparatus of claim 59, further comprising a decoder adapted to decode, at least in part, the reference pulses to extract incremental data redundancy from the transmitted reference signal.

64. The apparatus of claim 63, wherein the decoder is further adapted to decode, at least in part, the data pulses to extract the incremental data redundancy from the transmitted reference signal.

65. The apparatus of claim 63, wherein the apparatus is implemented in a coherent receiver.

66. The apparatus of claim 63, further comprising a communication module adapted to communicate with a transmitter to invoke a capability of the transmitter to transmit the transmitted reference signal with the incremental data redundancy.

67. The apparatus of claim 59, further comprising a decoder adapted to decode, at least in part, the reference pulses to extract an additional data stream from the transmitted reference signal.

68. The apparatus of claim 67, wherein the decoder is further adapted to decode, at least in part, the data pulses to extract the additional data stream from the transmitted reference signal.

69. The apparatus of claim 67, wherein the apparatus is implemented in a coherent receiver.

70. The apparatus of claim 67, further comprising a communication module adapted to communicate with a transmitter to invoke a capability of the transmitter to transmit the transmitted reference signal with the additional data stream.

71. The apparatus of claim 59, wherein the apparatus is implemented in at least one of the group consisting of: a headset, a microphone, a biometric sensor, a heart rate monitor, a pedometer, an EKG device, a user I/O device, a watch, a remote control, and a tire pressure monitor.

72. An apparatus for processing a transmitted reference signal including reference pulses and data pulses, comprising:
means for receiving reference pulses and data pulses of a transmitted reference signal; and
means for demodulating data transmitted in the transmitted reference signal, at least in part, in accordance with changes in phase of the reference pulses.

73. The apparatus of claim 72, wherein the changes in phase further comprise changes in polarity.

74. The apparatus of claim 72, wherein the means for demodulating data further comprises means for detecting random or pseudo-random changes in the phase of the reference pulses.

75. The apparatus of claim 72, wherein the transmitted reference signal further comprises an ultra-wide band signal having a fractional bandwidth on the order of 20% or more or having a bandwidth on the order of 500 MHz or more.

76. The apparatus of claim 72, wherein the means for demodulating data further comprises means for decoding, at least in part, the reference pulses to extract incremental data redundancy from the transmitted reference signal.

77. The apparatus of claim 76, further comprising means for decoding, at least in part, the data pulses to extract the incremental data redundancy from the transmitted reference signal.

78. The apparatus of claim 76, wherein the apparatus is implemented in a coherent receiver.

79. The apparatus of claim 76, further comprising means for communicating with a transmitter to invoke a capability of the transmitter to transmit the transmitted reference signal with the incremental data redundancy.

80. The apparatus of claim 72, wherein the means for demodulating data further comprises means for decoding, at least in part, the reference pulses to extract an additional data stream from the transmitted reference signal.

81. The apparatus of claim 80, further comprising means for decoding, at least in part, the data pulses to extract the additional data stream from the transmitted reference signal.

82. The apparatus of claim 80, wherein the apparatus is implemented in a coherent receiver.

83. The apparatus of claim 80, further comprising means for communicating with a transmitter to invoke a capability of the transmitter to transmit the transmitted reference signal with the additional data stream.

84. The apparatus of claim 80, wherein the apparatus is implemented in at least one of the group consisting of: a headset, a microphone, a biometric sensor, a heart rate monitor, a pedometer, an EKG device, a user I/O device, a watch, a remote control, and a tire pressure monitor.

85. A computer-program product for processing a transmitted reference signal including reference pulses and data pulses comprising:
a computer-readable medium comprising codes for causing a computer to:
receive reference pulses and data pulses of a transmitted reference signal; and
demodulate data transmitted in the transmitted reference signal, at least in part, in accordance with changes in phase of the reference pulses.

86. A processor for processing a transmitted reference signal including reference pulses and data pulses, the processor being adapted to:
receive reference pulses and data pulses of a transmitted reference signal; and
demodulate data transmitted in the transmitted reference signal, at least in part, in accordance with changes in phase of the reference pulses.
